(19) United States
(12) Patent Application Publication
(10) Pub. No.: US 2005/0246982 A1
(43) Pub. Date: Nov. 10, 2005

(54) Floor box and cover therefor

(75) Inventors: Geoff D. MacMillan, Kitchener (CA); Paul W. Ziegler, Fergus (CA); Andrew James Halliday, Fergus (CA); Neil Sutton, Guelph (CA)

Correspondence Address: MCCORMICK, PAULDING & HUBER LLP, CITY PLACE II, 185 ASYLUM STREET, HARTFORD, CT, 06103, US

(73) Assignee: The Wiremold Company, West Hartford, CT (US)

(21) Appl. No.: 11/011,309

(22) Filed: Dec. 13, 2004

Related U.S. Application Data
(60) Provisional application No. 60/569,191, filed on May 7, 2004.

(51) Int. Cl. B60R 9/00; E04C 2/52

(52) U.S. Cl. 52/220.8

(57) ABSTRACT

A floor box for providing access to multiple utilities in a floor structure. The floor box includes a housing having a bottom wall and one or more side walls extending from the bottom wall and defining an interior space therebetween. A partition wall attached to the bottom wall and the side walls partially divides the interior space. A flange is attached at the upper edges of the side walls and includes a surface extending outwardly therefrom. A cover assembly includes a frame mounted to the flange. The frame has a cross member overlying the partition wall and cooperating therewith to divide the interior space into first and second compartments. The cover assembly further includes first and second access doors movable relative to the frame between open and closed positions for providing access to the first and second compartments respectively. A gasket seals the first and second compartments.

### CROSS REFERENCE TO RELATED APPLICATIONS

This application claims priority to U.S. Provisional Patent Application No. 60/569,191 filed on May 7, 2004 entitled “Hinged Cover Assembly For In-Floor Fitting”. The disclosure of the above-identified provisional application is incorporated herein by reference. Additionally, the present application represents an improvement of that disclosed in U.S. Pat. No. 6,462,277 entitled “Cover Assembly For An In-Floor Fitting”. Said U.S. Pat. No. 6,462,277 is incorporated by reference herein.

### FIELD OF THE INVENTION

The present invention generally relates to a floor box for providing access to utilities in a floor structure, and more particularly to a floor box having separate sealed compartments for providing access to multiple utilities at a floor structure.

### BACKGROUND OF THE INVENTION

Often, large buildings such as convention centers, exhibition centers, arenas and other facilities provide utility services at certain locations throughout a floor of the facility. Usually, electrical power, communication ports, and plumbing hook-ups are provided in separate fixtures at various locations of the floor. To provide multiple utilities to a single location on the floor of the facility, such as for an exhibit or vendor booth, temporary supply lines are often run over the surface of the floor from multiple floor fixtures to the desired location. Temporary conduit or tape is usually needed to cover the temporary supply lines.

Further, prior art floor fixtures are often not designed to exclude scrub water or floor cleaning solutions from entering the fixtures. Additionally, many prior art floor fixtures are not designed to withstand heavy loads such as vehicles or heavy equipment which is often utilized in large facilities.

Based on the foregoing, it is the general object of the present invention to provide a floor box that improves upon, or overcomes the problems and drawbacks associated with prior art floor boxes.

### SUMMARY OF THE INVENTION

The present invention is directed to a floor box for providing access to utilities in a floor structure. The floor box includes a housing having a bottom wall and four sidewalls extending from the bottom wall and defining an interior space therebetween. An upper edge of each of the sidewalls cooperate to define an opening to the interior space. A partition wall attached to the bottom wall and two of the sidewalls partially divides the interior space. A flange is attached at the upper edges of the sidewalls and defines a peripherally extending recess that includes a upwardly facing surface extending outwardly therefrom.

A cover assembly includes a frame supported on the upwardly facing surface of the flange. The frame has a cross member overlying the partition wall and cooperating therewith to divide the interior space into first and second compartments. The cover assembly further includes first and second access doors movable relative to the frame between open and closed positions for providing access to the first and second compartments respectively. At least one of the access doors defines a line opening for allowing a line to pass therethrough when the access door is in the closed position.

A seal is provided between the upwardly facing surface of the peripheral flange and the frame of the cover assembly. The seal also includes a portion between the cross member and an upper edge of the partition wall for sealing the first and second compartments. The housing walls define openings for supplying utilities the first and second compartments.

Mounting brackets are provided for locating the housing above a sub-floor such that an upper surface of the first and second access doors is generally flush with the top surface of the floor structure when the access doors are in the closed position.

A panel is disposed within one of the first and second compartments for supporting a utility receptacle or device. In a preferred embodiment, the panel is attached to a wiring carriage removably mounted in one of the compartments. The wiring carriage being removable for facilitating wiring and/or installing utility receptacles or devices on the panel.

A drain opening is preferably provided in one of the housing walls, usually the bottom wall for receiving a drain fitting and coupling a drainpipe to the housing. In a preferred embodiment, a check valve is provided in-line with the drainpipe for preventing back flow from entering the interior space defined by the housing.

The housing is designed so that electrical receptacles or devices and/or communications ports or devices can be mounted in the first compartment and one or more fluid couplers can be mounted in the second compartment such that the electrical and communications equipment and the fluid couplers are separated one from the other in the first and second sealed compartments respectively.

Thus, the present invention provides a floor box having first and second sealed compartments wherein multiple utility services can be sealed one from the other in the separate compartments. Accordingly, the floor box of the present invention can be configured to provide access to electrical power, communications ports, water, drain, compressed air as well as other utilities all from a single location in the floor of a facility. Additionally, the present invention discloses a floor box designed to meet UL (Underwriter's Laboratories) and other standards for convention floor type boxes. Further, the floor box of the present invention is preferably pre-wired such that the only connections necessary during an installation process are to connect power or communication supply lines to a main panel or distribution box within the wiring carriage provided.

The foregoing and other objects and advantages of the present invention will be more apparent from the detailed description of the preferred embodiments of the invention in connection with the accompanying drawings wherein throughout the figures, like reference numerals describe like elements of the invention.

### BRIEF DESCRIPTION OF THE DRAWINGS

FIG. 1 is a side cross-sectional view of a floor box in accordance with the present invention.

FIG. 2 is a perspective view of the housing of the floor box of FIG. 1.

FIG. 3 is an enlarged detail view of the area A of FIG. 1.

FIG. 4 is cross sectional view of another embodiment of a floor box in accordance with the present invention shown installed in a floor structure

FIG. 5 is a top view of the floor box of FIG. 1 shown without the cover assembly.

FIG. 6 is an exploded perspective view of another embodiment of a floor box in accordance with the present invention.

FIG. 7 is a perspective view of the cover assembly of the floor box of FIG. 1 with one of the access doors in an open position.

FIG. 8 is a perspective view of the frame of the cover assembly of FIG. 7.

FIG. 9 is an enlarged detail view of the area B of FIG. 8.

FIG. 10 is a perspective view of the cover assembly of FIG. 7 with both of the access doors in the closed position.

FIG. 11 is an enlarged detail view of the area C of FIG. 10.

FIG. 12 is a detail view of the hinges for the access doors of the cover assembly of FIG. 7.

FIG. 13 is a perspective view of the top side one of the access doors of the cover assembly of FIG. 7 shown removed from the frame.

FIG. 14 is a perspective view of the lower side of the access door of FIG. 13.

FIG. 15 is a side view of the access door of FIG. 13.

FIG. 16 is an end view of the access door of FIG. 13.

FIG. 17 is an enlarged detail view of the area D of FIG. 15.

FIG. 18 is an enlarged detail view of the area D of FIG. 14.

FIG. 19 is a perspective view of an egress door of the cover assembly of FIG. 7.

FIG. 20 is a top view of the egress door of FIG. 19.

FIG. 21 is a side view of the egress door of FIG. 19.

FIG. 22 is an end view of the egress door of FIG. 19

FIG. 23 is an enlarged detail view of the area F of FIG. 21.

FIG. 24 is a partial view of a housing and wiring carriage of yet another embodiment floor box according to the present invention.

FIG. 25 is an end view of the floor box of FIG. 1 shown installed on a sub-floor.

FIGS. 26 and 27 are enlarged detail views of areas G and H of FIG. 25 respectively.

FIG. 28 is a side view of the floor box of FIG. 1 shown installed on a sub-floor.

FIG. 29 is a side view of the floor box of FIG. 1 shown mounted in an opening in a floor decking.

FIG. 30 is an enlarged detail view of the area I of FIG. 29.

FIG. 31 is a perspective view of the floor box of FIG. 29.

FIG. 32 is an enlarged detail view of the area K of FIG. 31.

FIG. 33 is an end view of the floor box of FIG. 29.

FIG. 34 is an enlarged detail view of the area J of FIG. 33.

### DETAILED DESCRIPTIONS OF PREFERRED EMBODIMENTS

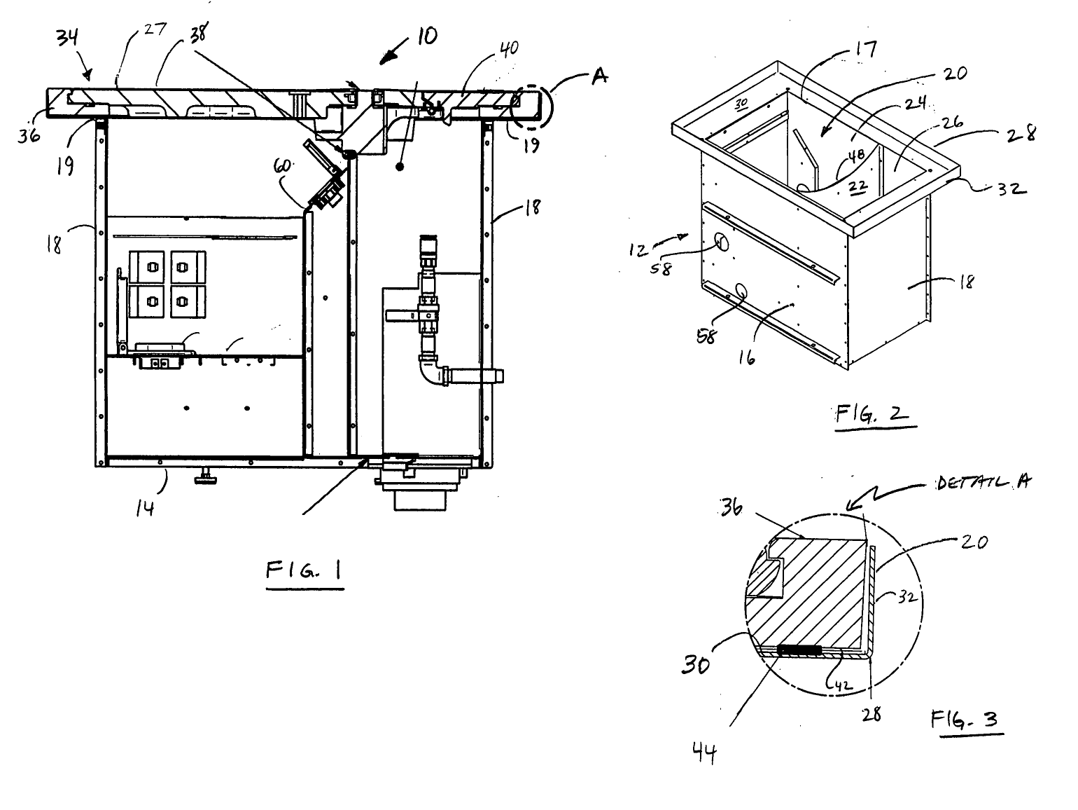

Referring to FIGS. 1-3, a floor box 10 includes a rectangular housing 12 having a bottom wall 14, a pair of side walls 16 and a pair of end walls 18. The side walls 16 and end walls 18 extend generally perpendicular from the bottom wall 14 and cooperate therewith to define an interior space 20.

A partition wall 22 attached to side walls 16, 16 and bottom wall 14 partially divides the interior space 20 into first and second compartments 24 and 26 respectively. A sealant (not shown) such as a gasket material or silicone can be used to seal the joints between the partition wall 22 and the side walls 16, 16 and the partition wall and the bottom wall 14 such that the first and second compartments 24 and 26 respectively, are sealed one from the other. Depending on the sealer used, air, liquids, dirt as well as other materials are prevented from passing between the first compartment 24 and the second compartment 26. Alternatively, in other embodiments of the present invention, the housing 12 can include a partition wall that is seam welded to the side and bottom walls of the housing thereby eliminating the need for a sealer therebetween. Further, in embodiments of the invention wherein the housing is formed of a polymeric or composite material, the partition wall may be manufactured integral with the housing walls or attached thereto in a continuous joint such that a sealer is unnecessary.

Preferably, the housing 12 is constructed of fourteen gauge galvanized steel painted with fusion bonded Epoxy Powder Coat. However, the housing can also be manufactured from stainless steel or other metals. Alternatively, as mentioned above, the housing 12 can be constructed from PVC or other polymeric/composite materials.

Each of the side walls 16, 16 defines an upper edge 17. Similarly, each of the end walls 18, 18 defines an upper edge 19. A flange 28 is supported by and may be welded to the upper edges 17 of each of the side walls 16, 16 and upper edges 19 of each of the end walls 18, 18 and defines a recess having an upwardly facing surface 30 extending outwardly of the side and end walls. The upper surface 30 of the flange 28 extends generally parallel with the plane of the bottom wall 14. The recess in the flange 28 is also defined in part by an upstanding wall portion 32 attached at the perimeter of the surface 30 forming an outermost edge of the recess. It is noted that the flange 28 or a portion thereof, can be formed integral with the walls of the housing 12.

In other embodiments of the present invention, the housing 12 can include first and second housings each having a bottom wall and one or more side walls positioned adjacent on another so that the adjacent side walls cooperate to form a partition wall between first and second compartments defined by the first and second housings respectively. The first and second housings can be attached together at the adjacent side walls or positioned one next to the other for attachment with a common cover assembly.

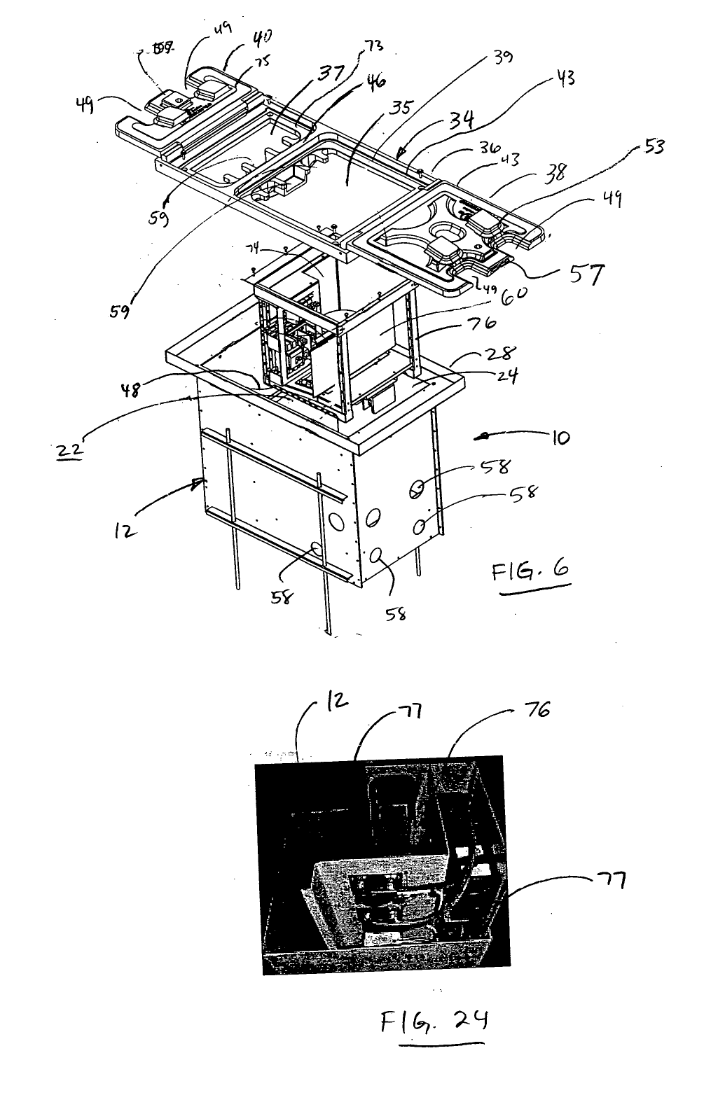

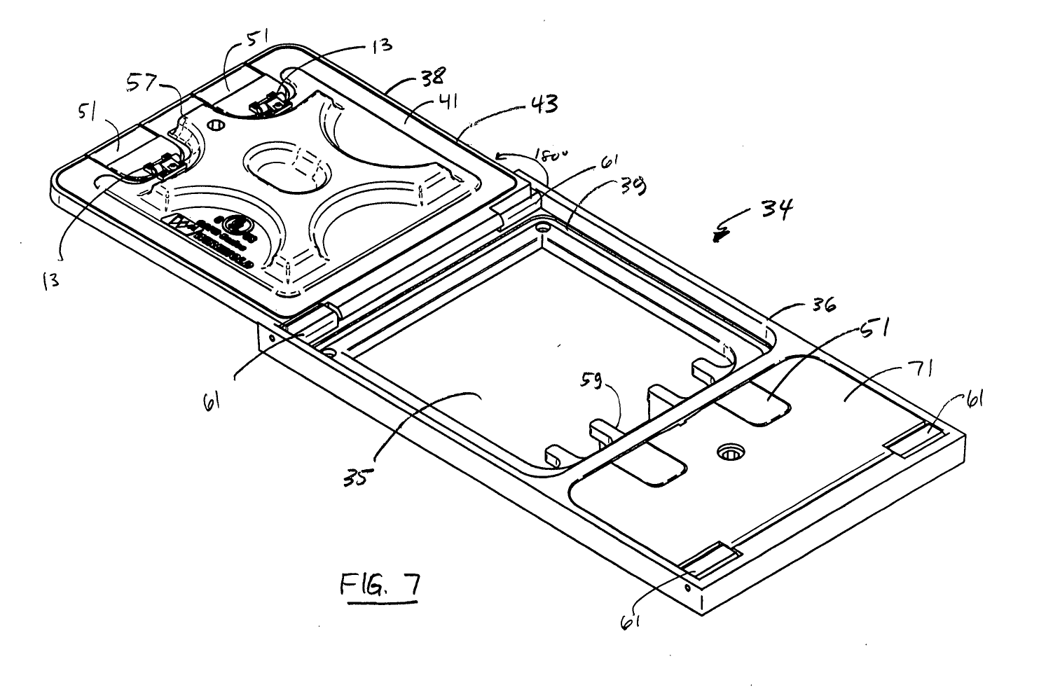

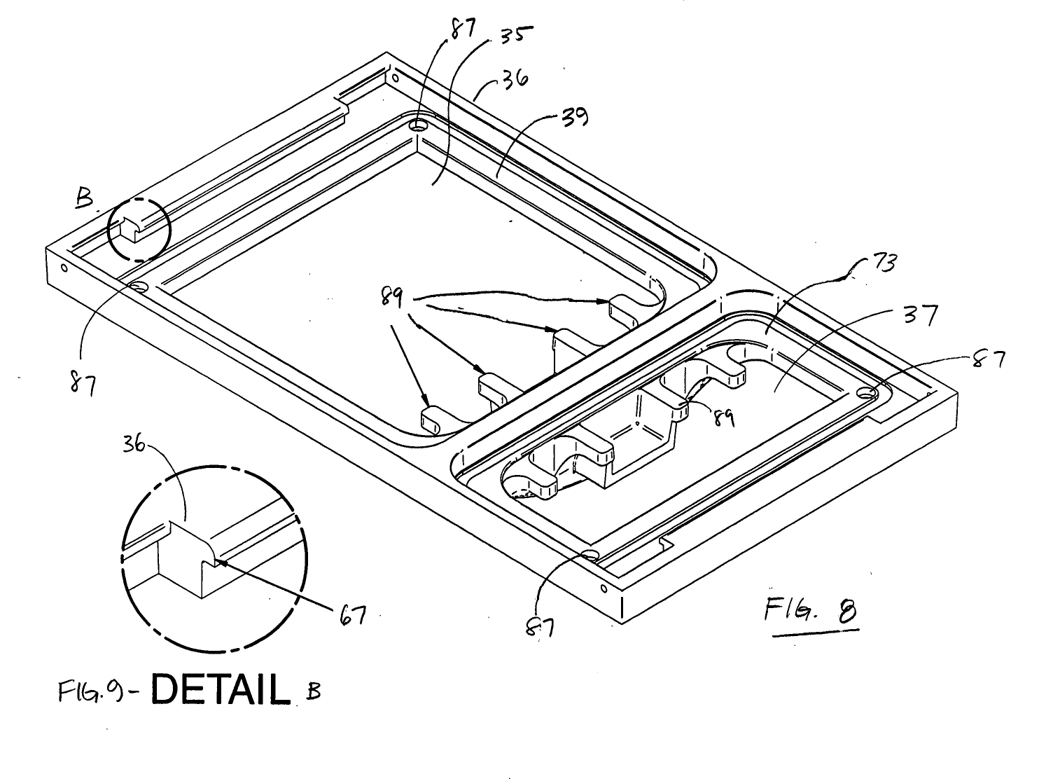

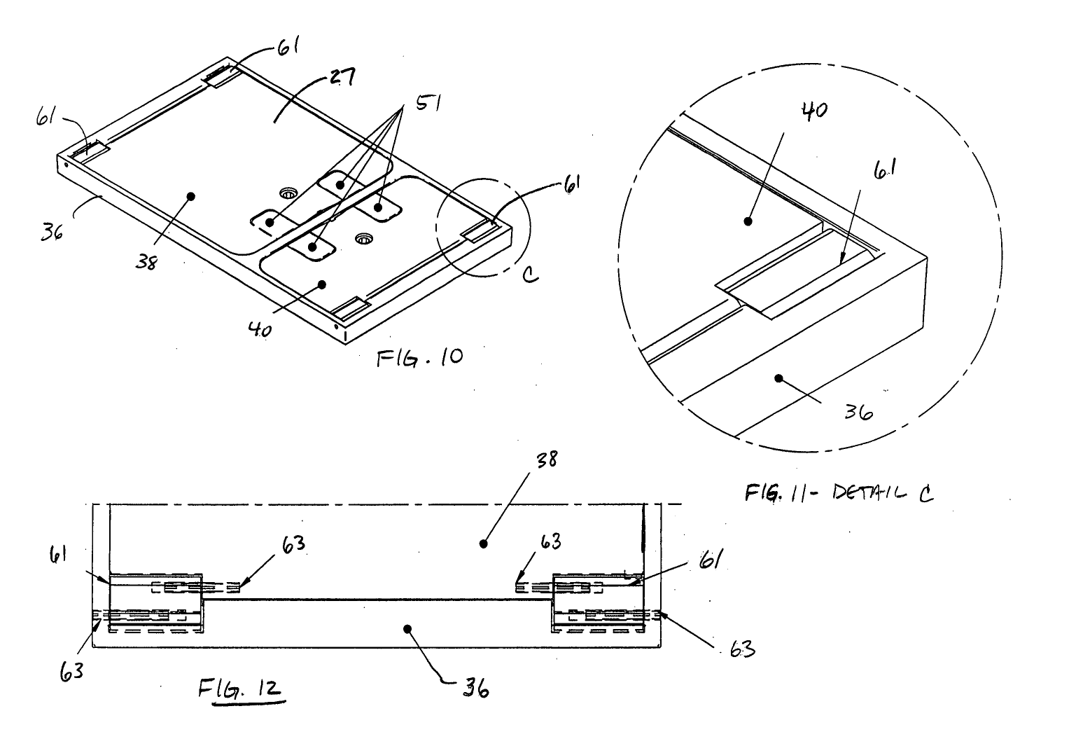

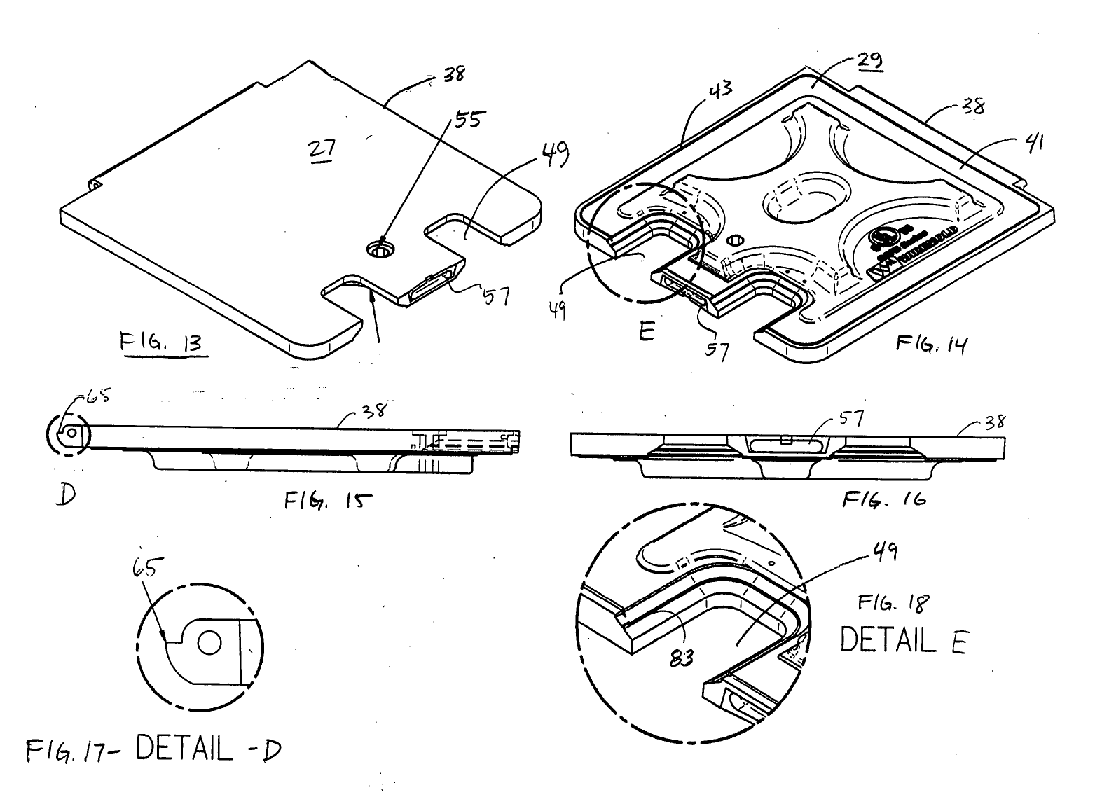

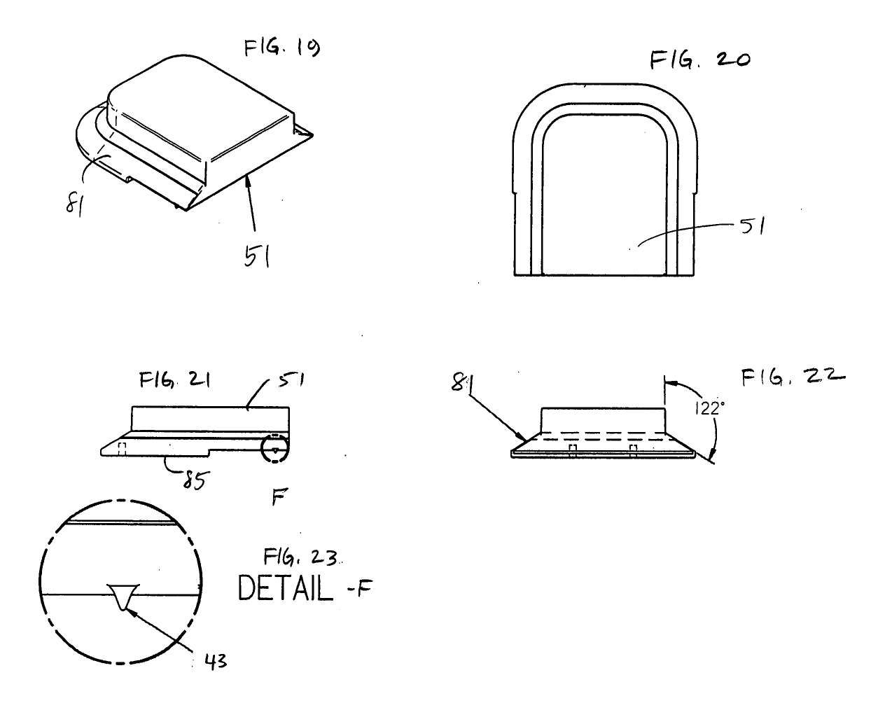

Referring to FIGS. 1, 4 and 6-22, a cover assembly, generally referred to by the reference numeral 34 includes a frame 36 received in the recess of the flange 28. The frame 36 defines a first opening 35 aligned with the first compartment 24. A first access door 38 hingedly coupled to the frame 36 is movable between open and closed positions relative to the first opening 35 for providing access to the first compartment 24. As shown in FIGS. 7-18, a pair of hinges 61,61 are coupled to both the first access door 38 and the frame 36 via spring pins 63 and pivotally mount the first access door to the frame. Referring to FIGS. 8, 9, 15, and 17, with respect to the first access door 38, the access doors 38, 40 each define a retention nose 65 engageable with a retention lip 67 formed on the frame 36 further supporting the access door in the closed position and preventing the access door from closing beyond the closed position and into the first compartment 24. In the closed position, an upper surface 27 of the first access door 38 is approximately flush with the surface 54 of a floor structure 56.

Referring again to FIG. 7, the first access door 38 opens approximately 180 degrees relative to the frame 36 such that in the open position, the upper surface 27 of the first access door is supported by the surface 54 of the floor structure 56 adjacent to the floor box 10. A lock 55 and lock mechanism 57 mounted to the first access door 38 cooperate with a corresponding lock portion 59 of the frame 36 to secure the first access door in the closed position. Surrounding the first opening 35, the frame 36 defines a recessed surface 39 for engaging a lower surface 41 of the first access door 38 and supporting the first access door when in the closed position. A door seal 43 is attached to a lower surface 29 of the access door 38 for engagement with the recessed surface 39 for sealing the first compartment 24 when the first access door is in the closed position.

Similarly, the frame 36 defines a second opening 37 aligned with the second compartment 26. A second access door 40 is hingedly coupled to the frame 36 and movable between open and closed positions relative to the second opening 37 for providing access to the second compartment 26. The second access door 40 is also coupled to the frame 36 via hinges 61 and spring pins 63 as set forth above with respect to the first access door 38. In the closed position, an upper surface 71 of the second access door 40 is approximately flush with the surface 54 of the floor structure 56. The second access door 40 opens at least approximately 180 degrees relative to the frame 36 such that in the open position, the upper surface 41 of the second access door is supported by the surface 54 of the floor structure 56 adjacent to the floor box 10. A lock 55 and lock mechanism 57 mounted to the second access door 40 cooperates with a corresponding lock portion 59 of the frame 36 to secure the second access door in the closed position. In the closed position, the second access door 40 is received in a recessed area 73 defined by the frame 36 as set forth above with respect to the first access door 38. The second access door 40 also includes a door seal 43 attached to a lower surface 75 of the access door 40 for engagement with the recessed surface 73 for sealing the second compartment 26 when the second access door is in the closed position. In the FIG. 1 embodiment, the first and second access doors 38 and 40 respectively, are shown to be of different sizes wherein the first access door 38 is larger than the second access door 40. However, the floor box of the present invention is not limited in this regard as each of the first and second access doors and corresponding first and second compartments can be of various sizes and numbers depending on the application. Thus, the floor box of the present invention may include three or more separate compartments and corresponding access doors.

Referring again to FIGS. 7-23, each of the first and second access doors 38 and 40 respectively, define line openings 49 for allowing temporary lines (not shown) coupled to utility receptacles inside the floor box 10 to pass through the access doors when the access doors are in the closed position. A corresponding egress door 51 cooperates with each of the line openings 49 for closing the line openings when not in use. Each of the egress doors 51 are hingedly coupled to one of the access doors 38, 40 such that the egress doors open into a corresponding one of the first and second compartments 24 and 26. In the preferred embodiment, each of the egress doors 51 are mounted to one of the access doors 38, 40 using a friction hinge 13 as shown in FIG. 7. The friction hinge 13 acts to maintain the position of the egress door. Thus, if the egress door 51 is placed in an open position to allow a supply line to pass through a corresponding line opening 49 in the access door, the friction hinge 13 will retain the egress door in the open position. The friction hinges 13 on the egress doors 51 are especially advantageous when a user of the floor box 10 is opening or closing the access doors 38, 40 with supply lines attached to couplers provided inside the floor box while taking precaution so as not to damage the supply lines. In other embodiments, the egress doors are bias towards a closed position. A spring (not shown) is coupled to each egress door 51 and configured to bias the egress door towards a closed position flush with a corresponding one of the access doors 38, 40.

Referring to FIGS. 14 and 18, an egress door seal 83 is attached to the access doors 38, 40 at the perimeter of each of the line openings 49 and engages the corresponding egress door 51 at an angled gasket edge 81 for sealing the line opening 49 when the egress door is in the closed position. At the perimeter of the line openings 49, the first and second access doors 38 and 40 define an angled surface corresponding to the angled gasket edge 81 on the egress doors for engagement therewith. As illustrated in FIGS. 21 and 23, a top surface 85 of each of the egress doors 51 includes a portion of the door seal 43 attached thereto that is engageable with the recessed surfaces 39 and 73 of the frame 36 for sealing the first and second compartments 24 and 26 when the access doors 38 and 40 are in the closed position and the egress doors 51 are not used and thus also in a closed position.

As shown in FIG. 3, the frame 36 is disposed in an area formed by the upper surface 30 and wall portion 32 of the flange 28. A lower surface 42 of the frame 36 is supported by the upper surface 30 of the flange 28. A flange seal 44 is disposed between the upper surface 30 of the flange 28 and the lower surface 42 of the frame 36 sealing the frame to the flange. In the preferred embodiment, the frame 36 is bolted to the upper surface 30 of the flange 28 at bolt holes 87 defined by the frame. The flange seal 44 is designed to prevent water, dirt and debris from entering the first and second compartments 24 and 26 respectively.

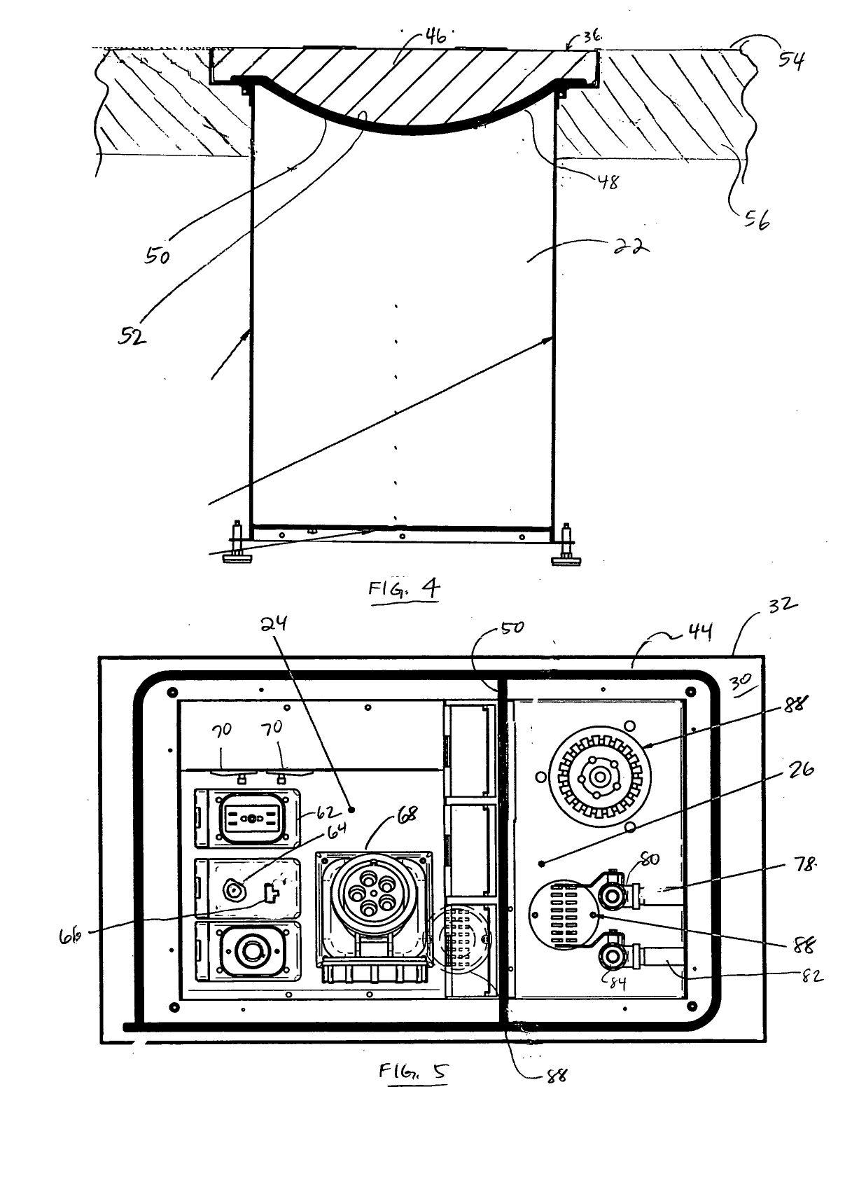

Referring to FIGS. 4 and 6, the frame 36 includes a cross member 46 configured to engage an upper edge 48 of the partition wall 22 when the frame is attached to the housing 12. A cross member seal 50 is disposed between a lower surface 52 of the cross member and the upper edge 48 of the partition wall 22 providing a seal between the first and second compartments 24 and 26. The cross member seal 50 is for preventing liquids and other materials from passing between the first and second compartments 24 and 26 respectively. As shown in FIG. 5, the cross member seal 50 and the flange seal 44 can be formed from a single gasket. The cross member 46 further defines a plurality of fingers extending outwardly from the cross member into the openings 35 and 37. The fingers 89 support the first and second access doors 38 and 40 respectively, adjacent the line openings 49 defined thereby and further act as separators for locating supply lines passing through the access doors at the line openings. The fingers 89 act to align the supply lines with the line openings 49 and the corresponding egress doors 51 so that the access doors 38, 40 can be easily opened and closed without the supply lines making contact with the access doors 38, 40 and egress doors 51, thereby minimizing the risk of damaging the supply lines during opening and closing the access doors. The fingers 89 are especially helpful when large wires or cables are routed through the line openings 49 into the floor box 10.

The configuration of the floor box 10 meets or exceeds UL scrub water exclusion requirements for most floors including both tile and carpeted floors as set forth following. In combination, the flange 28 the cover assembly 34, flange seal 44 and cross member seal 50 cooperate to exclude scrub water from entering the first and second compartments from the surface of the floor structure. Additionally, the access doors 38 and 40 when in the closed position are sealed via the door seal 43 to prevent scrub water from entering the housing 12 through the openings 35, 37 in the frame 36. When the access door 38 or 40 is locked in the closed position via the lock 55, the retention nose 65 on the access door engages the retention lip 67 defined by the frame 36 providing a downward force at a hinge side of the access door. This downward force at the hinge side of the access door 38 or 40 combines with a downward force at the lock side of the access door provided by the lock 55 secured to the lock mechanism 57 such that the door seal 43 is compressed between the lower surface of access door 29 and the recessed surface 39 of the frame 36 sealing the corresponding first or second compartment 24 or 26 from scrub water entering through the first or second opening 35, 37 in the frame.

Further, as set forth above, the egress doors 51 include a portion of the door seal 43 such that when an egress door 51 is in the closed position and the corresponding access door 38 or 40 is also in the closed position, the opening 35 or 37 in the frame at the access door is also sealed such that scrub water is excluded from the first and second compartments 24 or 26.

Additionally, the seal between the partition wall 22 and the housing side walls in conjunction with the cross member seal 50 prevent water from passing between the first and second compartments 24 and 26 respectively, sufficiently to meet or exceed UL standards for a volume overflow test of one of the compartments. Thus, if one of the first and second compartments is flooded with water, the water will not enter the other of the compartments.

Because of the scrub water exclusion features and the sealed partition wall 22 separating the first and second compartments 24 and 26, the present invention floor box meets UL standards without a requirement to have GFCI (Ground Fault Circuit Interrupters) or weather proof covers on electrical devices over 20 Amperes. Thus, the present invention floor box 10 meets or exceeds UL standards with the use of less expensive electrical devices for circuits over 20 Amperes.

In the FIG. 4 embodiment, the lower surface 52 of the cross member 46 is arcuate and extends into the interior space 20 when the cover assembly 34 is attached to the housing 12. The arcuate lower surface 52 provides a larger cross member 46 than if the lower surface 52 were straight, thereby enabling the floor box 10 to withstand a heavier load at the surface 54 of the floor structure 56. In a preferred embodiment, the cover assembly 34 is manufactured from cast aluminum providing both strength and ease of use. As shown in FIGS. 4, and 6, the cover assembly 34 is made of cast aluminum designed to support a 32,000 pound load on a footprint of approximately 1″×16″ with a safety factor of two (64,000 lbs.).

Referring to FIGS. 1, 2 and 5, the first compartment 24 is configured for providing access at the floor structure 56 to electrical and communications services while the second compartment 26 is configured to provide access to water, compressed air or other fluids or gases. Supply lines (not shown) provide these services to the first and second compartments through one or more openings 58 defined by the walls of the housing 12. The openings 58 can include punched entry locations including pre-cut knockouts and brackets therefor. Clamping and/or sealing devices can be provided for clamping and/or sealing the supply lines entering and/or exiting the housing 12 at the openings 58.

A first panel 60 is mounted in the first compartment 24 for supporting an electrical receptacle 62 and communication ports 64 and 66. The communications ports 64 and 66 can include a plurality of telephone, video and data ports. A pin and sleeve electrical coupler 68 is mounted to a second panel 70. Circuit breakers 72 are mounted to a third panel 74. Power distribution boxes (not shown) can also be included so that electrical power can be split and provide electrical power to a plurality of receptacles from a single source line.

Referring to FIG. 6, the floor box 10 includes the panels 60 and 74 mounted to a wiring carriage 76. The wiring carriage 76 is removably mounted in the first compartment 24 so that the electrical and communications components can be connected to supply lines as necessary prior to positioning the wiring carriage in the housing 12. Typically, installation of electrical and communications equipment and the wiring thereof is done after the floor box 10 is installed into the floor structure 56 thus resulting in connections being made below the surface 54 of the floor structure. Thus, the removable wiring carriage 76 is advantageous in that the entire wiring carriage can be removed from the housing 12 for installing receptacles and equipment and making connections thereto. In the FIG. 24 embodiment, the wiring carriage 76 is slidably mounted to the housing 12 on track members 77 such that the wiring carriage can be raised relative to the housing for facilitating installing and wiring equipment mounted thereto.

Alternatively, the wiring carriage 76 can be pre-wired including pre-installed receptacles and equipment such that only power and/or other supply lines need to be coupled to main panels after the floor box 10 is installed in the floor structure 56.

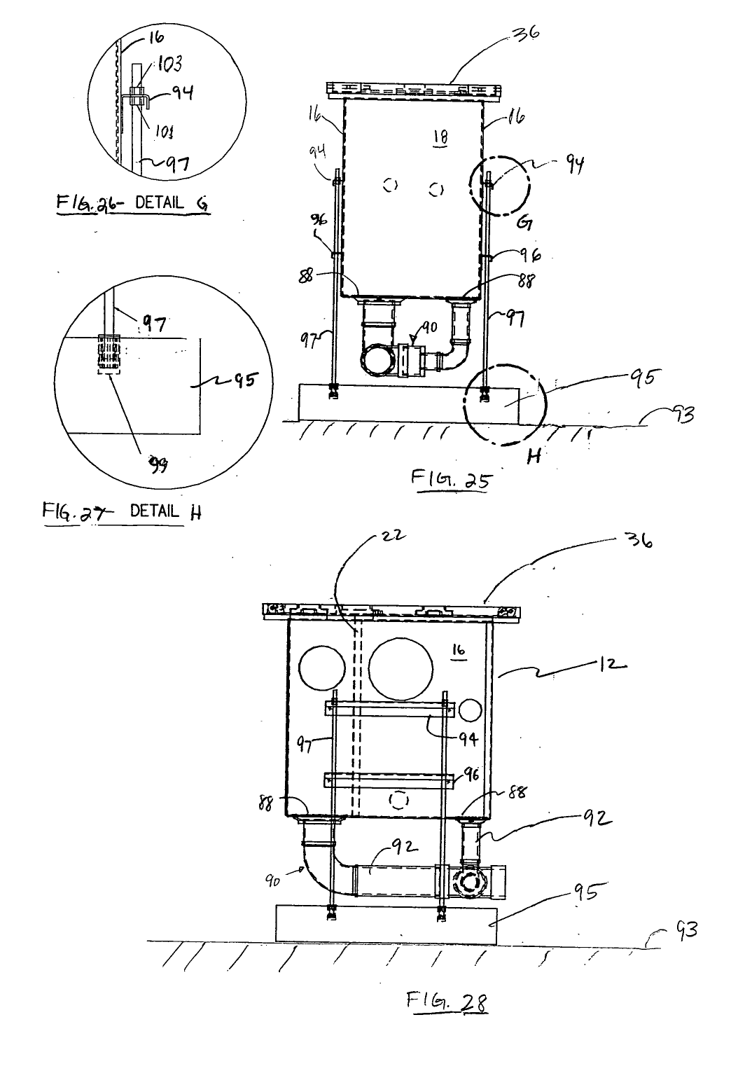

Referring to FIG. 5, a water line 78 and shut-off valve 80 provides water to the second compartment 26. A compressed air supply line 82 and shut-off valve 84 is also mounted in the second compartment 26 for providing access to compressed air at the floor structure 56. Additionally, other fluid or gas lines can be provided in the second compartment 26 for supplying services to a floor structure 56. Further, a drain or sewer pipe can be provided interior the second compartment 26 for attaching temporary drain or sewage lines thereto. Drain fittings 88 are also provided in corresponding openings in the walls of the housing 12 for draining the first and second compartments 24 and 26. As shown in FIGS. 25 and 28, drain pipes 90 coupled to the drain fittings 88 are configured to connect to a drainage system. Check valves 92 are provided to prevent back flow from entering the first and second compartments 24 and 26 from the drainage system.

Referring to FIGS. 25-28, the housing 12 is supported on a sub-floor 93 positioned below the floor structure 56. A pre-formed concrete pad 95 positioned on the sub-floor 93 supports a threaded rod 97 near each corner of the housing 12. Upper and lower mounting brackets 94 and 96 respectively, are attached to each side wall 16 of the housing 12 and extend generally parallel to the bottom wall 14 of the housing. Each of the rods 97 are coupled to anchors 99 disposed in the concrete pad 95 and arranged to pass through apertures in each of the upper and lower mounting brackets 94 and 96 respectively. A pair of nuts 101, 103 secure the upper mounting brackets 94 to each of threaded rods 97 at an appropriate height relative to the sub-floor 93 such that the cover assembly 36 is aligned flush with the surface 54 of the floor structure 56. Typically, a lower nut 101 is used to establish the elevation of the housing 12 at each corner thereof and an upper nut 103, when tightened to the lower nut with the upper mounting bracket 94 therebetween, secures the elevation of the housing relative to the sub-floor 93. Additionally, as shown in FIG. 4, the housing 12 can be supported on a sub-floor via adjustable legs located one each at the lower corners of the housing.

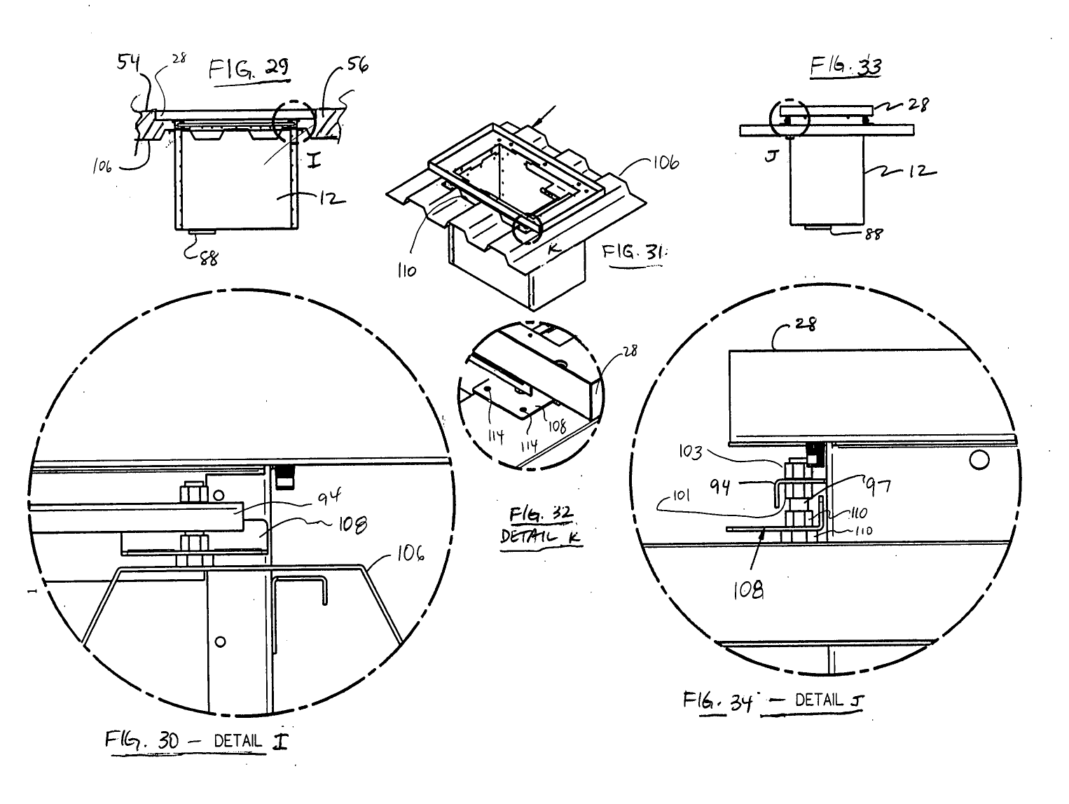

Alternatively, as shown in FIGS. 29-34, the housing 12 is mounted to a floor decking 106 such that the flange 28 is spaced from the floor decking so that the upper surface of the frame 36 is aligned with a surface 54 of the floor structure 56. On each side of the housing 12, the upper mounting bracket 94 attached to the side wall 16 of the housing 12 is coupled to a pair of mounting feet 108 via a threaded rod 97. As shown in FIG. 31, the housing 12 extends through an opening 110 in the floor decking 106 and is suspended therefrom. The position of the threaded rods 97 relative to the upper mounting bracket 94 is adjustable along the length of the mounting bracket 94 such that mounting feet 108 are attachable to the ribs 112 of the floor decking 106. As shown in FIG. 34, the threaded rod 97 is secured to the mounting feet 108 via a pair of nuts 110. As set forth above, a lower nut 101 threadably coupled to the rod 97 is used to establish the elevation of the housing 12 at each corner thereof and an upper nut 103, also threaded to the rod 97, when tightened to the lower nut with the upper mounting bracket 94 therebetween, secures the elevation of the housing relative to the floor decking 106. Referring to FIG. 32, the mounting feet 108 are secured to the ribs 112 of the floor decking via screw holes 114.

In another embodiment of the present invention, an existing housing is retrofitted with the floor box of the present invention. In a retrofit application, one or more of a cover assembly, flange, partition wall, wiring carriage and panels in accordance with the floor box of the present invention are configured to be used with an existing housing. Thus, an existing housing can be modified to define first and second compartments sealed one from the other in accordance with the present invention.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

1. A floor box for providing access to utilities in a floor structure comprising:
a housing including a bottom wall and one or more side walls, said side walls extending from said bottom wall and defining an interior space, an upper edge of said side walls defining an opening to said interior space;
a partition wall attached to said bottom wall and said side walls, said partition wall at least partially dividing said interior space;
a flange at the upper edge of the side walls and defining a recess having an upper surface extending outwardly of said side walls;
a cover assembly including a frame provided in said recess, said frame having a cross member overlying said partition wall and cooperating therewith to divide said interior space into first and second compartments, said cover assembly further comprising first and second access doors movable relative to said frame between open and closed positions for providing access to said first and second compartments respectively, at least one of said access doors defining a line opening for allowing a line to pass therethrough when said at least one access door is in said closed position;
at least one gasket disposed between said upper surface of said flange and said frame and between said cross member and an upper edge of said partition wall for sealing said first and second compartments;
at least one opening defined in one of said housing walls for supplying utilities to one of said first and second compartments;
mounting means for locating said housing relative to a sub-floor so that an upper surface of said first and second access doors is generally flush with a top surface of said floor structure when said access doors are in said closed position; and
a panel disposed within one of said first and second compartments and supporting at least one utility receptacle or device for providing access to said utility at the floor structure.

2. The floor box according to claim 1 wherein at least one of said housing walls defines a drain opening.

3. The floor box according to claim 2 further comprising a drain fitting disposed in said drain opening for coupling a drain pipe thereto.

4. The floor box according to claim 3 wherein said drain pipe includes a check valve preventing backflow to said interior space.

5. The floor box according to claim 1 wherein a portion of said cross member extends below said flange into said interior space.

7. The floor box according to claim 1 wherein said cover assembly further comprises a hinge for coupling at least one of said first and second access doors to said frame.

8. The floor box according to claim 7 wherein said hinge allows said at least one of said first and second access doors to rotate at least approximately 180 degrees such that said upper surface of said access door is supportable on said floor structure adjacent said housing when said housing is mounted for use in said floor structure and said access door is in said open position.

9. The floor box according to claim 1 further comprising a wiring carriage removably mounted in one of said first and second compartments and wherein said panel is mounted to said wiring carriage, said wiring carriage being removable for facilitating access to said panel and said utility receptacle or device.

10. The floor box according to claim 1 further comprising at least one of an electrical receptacle and communications connector mounted in one of said first and second compartments and a fluid coupler mounted in the other of said first and second compartments such that said at least one of an electrical receptacle and communications connector and said fluid coupler are separated in said first and second sealed compartments.

11. The floor box according to claim 1 wherein said mounting means further comprises bracket means attached to said side walls for locating said housing relative to said sub-floor.

12. The floor box according to claim 11 wherein said mounting means further comprises at least two support members, each attached between said bracket means and said sub-floor for supporting said housing.

13. The floor box according to claim 12 wherein said mounting means further comprises a pad positionable on said sub-floor for supporting said housing, said support members having a lower portion attached to said pad.

14. The floor box according to claim 1 wherein said utility receptacle or device includes one of an electrical receptacle or device, a communications port or device, and a fluid coupler or device.

15. The floor box according to claim 1 wherein at least one of said cover assembly access doors further comprises an egress door operable between open and closed positions for closing said line opening.

16. The floor box according to claim 1 wherein said frame further comprises a plurality of fingers extending from said frame into one of said first and second compartments, said fingers for locating a supply line entering said housing relative to said line opening defined by said at least one access door.

17. The floor box according to claim 15 wherein said egress door is hingedly mounted to one of said first and second access doors at said line opening via a friction hinge for retaining the egress door in one of an open and closed position.

18. A floor box for providing access to utilities in a floor structure comprising:
a housing including a bottom wall and one or more side walls, said side walls extending from said bottom wall and defining an interior space, an upper edge of each of said side walls defining an opening to said interior space;
a partition wall attached to said bottom wall and said side walls, said partition wall at least partially dividing said interior space;
a flange at the upper edge of said side walls and defining a recess with an upwardly facing surface extending outwardly from said side walls;
a cover assembly including a frame removably disposed in said recess, said frame having a cross member overlying said partition wall and cooperating therewith to divide said interior space into first and second compartments, said cover assembly further comprising first and second access doors movable relative to said frame between open and closed positions for providing access to said first and second compartments respectively, at least one of said access doors defining a line opening for allowing a line to pass therethrough when said at least one access door is in said closed position;
at least one gasket disposed between said upper surface of said flange and said frame and between said cross member and an upper edge of said partition wall for sealing said first and second compartments;
at least one opening defined in one of said housing walls for supplying utilities to one of said first and second compartments;
mounting means for mounting said housing such that an upper surface of said first and second access doors is generally flush with a surface of said floor structure when said access doors are in said closed position.
a wiring carriage positioned in one of said first and second compartments and including a panel mounted to said wiring carriage for supporting at least one utility receptacle or device and providing access to said utility at said floor structure.

19. The floor box according to claim 18 further comprising at least one of an electrical receptacle and communications connector mounted in one of said first and second compartments and a fluid coupler mounted in the other of said first and second compartments such that said at least one of an electrical receptacle and communications connector and said fluid coupler are separated in said first and second sealed compartments.

20. A cover assembly for use with a floor box defining an interior space for providing access to utilities in a floor structure, said cover assembly comprising:
a frame supported by an upper surface of said floor box;
a cross member overlying a partition wall disposed in said floor box and cooperating therewith to divide said interior space into first and second compartments; first and second access doors hingedly coupled to said frame movable between open and closed positions for providing access to said first and second compartments respectively, at least one of said access doors defining a line opening for allowing a line to pass therethrough when said at least one access door is in said closed position.

21. The cover assembly according to claim 20 further comprising a line access door operable between open and closed positions for sealing said line opening when not in use.

22. The cover assembly according to claim 20 further comprising at least one gasket disposed between said cross member and an upper edge of said partition wall for sealing said first and second compartments one from the other.
